(19) United States
(12) Patent Application Publication
(10) Pub. No.: US 2024/0426116 A1
(43) Pub. Date: Dec. 26, 2024

(54) Automatic film-extruding 3D printer

(71) Applicant: Winsun technology INC., Irvine, CA (US)

(72) Inventor: Yihe MA, Irvine, CA (US)

(73) Assignee: Winsun technology INC., Irvine, CA (US)

(21) Appl. No.: 18/341,417

(22) Filed: Jun. 26, 2023

(30) Foreign Application Priority Data
Jun. 24, 2023 (CN) 202221594012.8

(51) Int. Cl. E04G 21/02; B29C 64/118; B29C 64/209; B29C 64/236; B33Y 10/00; B33Y 30/00; B33Y 80/00

(52) U.S. Cl. CPC E04G 21/02; B29C 64/118; B29C 64/209; B29C 64/236; B33Y 10/00; B33Y 30/00; B33Y 80/00; B29L 2031/776

(57) ABSTRACT

This invention is in the field of 3D printers, specifically, an automatic film-extruding 3D printer. It set forth to address the issue of the existing printers which are large in size and inconvenient to transport. Before each print, substantial manpower and hoisting equipment are needed for assembly, and every relocation requires repetitive operations. These operations are not only costly but also time-consuming and labor-intensive. The disclosed solution comprises a support assembly, winch assembly, and moving assembly. The support assembly includes a fixed support and a mobile support, where the mobile support is slide-mounted on the fixed support. The winch assembly comprises a winch machine, two winch wheels, and two winch ropes. This 3D printer, in actual use, can quickly carry out film-extruding and printing on site. Compared with existing equipment, it can rapidly print walls and can be moved to different locations to print buildings without the need for disassembly.

### TECHNICAL FIELD

The present invention related to the field of three-dimensional (3D) printing for buildings, especially it is related to an automatic film extruding three-dimensional (3D) printer.

### BACKGROUND TECHNOLOGY

The term 3D printer typically refers to machines capable of three-dimensional printing, a sophisticated method of rapid prototyping. This technique involves building three-dimensional models via a layer-by-layer deposition process. At present, these printers tend to be large and heavy, often weighing in excess of 5 tons, which poses logistical challenges for transport. The preparatory phase for each printing cycle necessitates substantial manpower and the use of specialized hoisting equipment, with similar requirements for disassembly. Moreover, each relocation of the printer involves repeated processes that are not only cost-intensive but also consume considerable time and effort.

### SUMMARY OF THE INVENTION

One object of this invention is to address the shortcomings in the current technology by proposing an automatic film-extruding 3D printer.

To achieve the above objective, this application adopts the following technical scheme.

An automatic film-extruding 3D printer, which comprises a support assembly, a winch assembly, and a moving assembly. The support assembly comprises a fixed support and a mobile support. The mobile support is slide-mounted on the fixed support. The winch assembly comprises a winch machine, two winch wheels, and two winch ropes. The winch machine is firmly installed on the fixed support, and the two winch wheels are separately fixed onto two transmission shafts of the winch machine. The winch ropes are securely connected to the corresponding winch wheels.

Specifically, the moving assembly comprises a first 301—profile member, a first in/out material bin, a second 301—profile member, and a second in/out material bin. Both the first and second 301—profile members are fixedly mounted on the mobile support, with the first in/out material bin firmly attached to the side of the first 301—profile member.

Specifically, the second in/out material bin is firmly mounted on one side of the second 301—profile member. Both the first and second 301—profile members have rope fixing seats securely installed on them. The ends of the two winch ropes are separately affixed to the corresponding rope fixing seats.

Specifically, a roller groove is designed into the mobile support. A roller, installed in a rotatable manner on fixed support, is housed within the roller groove on the mobile support.

Specifically, multiple universal wheels are securely installed at the base of the fixed support.

Specifically, a controller is securely connected to the fixed support and is electronically connected to the winch machine.

Specifically, two auxiliary wheels are rotatably attached to the fixed support, and the winch ropes are correspondingly connected to the two auxiliary wheels.

Specifically, a rotational groove is provided on the fixed support. Each auxiliary wheel is affixed with a rotating block, which is rotatably installed within the rotational groove.

Compared to the existing technology, this invention offers the following benefits.

The designed automatic film-extruding 3D printer can achieve rapid film extrusion and printing onsite, thus enabling quicker wall printing compared to existing equipment. In addition, it can be maneuvered to different positions and locations to print structures/building without the need for disassembly.

### BRIEF DESCRIPTION OF THE DRAWINGS

To further describe the embodiments of this applications or the technical solutions in prior art, a brief introduction to the diagrams needed in the descriptions of the embodiments or existing technology will be provided. It is obvious that the diagrams described below are only illustrative. The structures, proportions, sizes, etc., depicted in this specification are solely to assist in revealing the content of the specification for the person ordinarily skilled in the art to understand and read, and are not intended to limit the scope of this application. Therefore, they do not have substantial technical significance, any modification to structures, changes in proportion relationships, or size adjustments.

FIG. 1 is a schematic diagram of the three-dimensional structure of an automatic film-extruding 3D printer disclosed by the present invention;

FIG. 2 is a schematic diagram of the front view structure of an automatic film-extruding 3D printer disclosed by the present invention;

FIG. 3 is a schematic diagram of the side view structure of an automatic film-extruding 3D printer disclosed by the present invention;

FIG. 4 is a schematic diagram of the structure of part A of an automatic film-extruding 3D printer disclosed by the present invention.

In the figures: 1—fixed support; 2—winch machine; 3—winch wheels; 4—mobile support; 5—first 301—profile member; 6—first in/out material bin; 7—second 301—profile member; 8—second in/out material bin; 9—universal wheels; 10—winch ropes; 11—rope fixing seats.

### DESCRIPTION OF EMBODIMENTS

The following explanation of specific embodiments will describe the methods of implementing the invention of this application. A persona ordinarily skilled in the art can easily understand other advantages and effects of this application from the content disclosed in this specification. Obviously, the described embodiments are part of the implementations of this application, not all. All other examples obtained by a person ordinarily skilled in the art in this field, without making a creative endeavor, belong to the scope protected by this utility application.

In the description of this utility application, it should be understood that terms such as “center,” “longitudinal,” “lateral,” “length,” “width,” “thickness,” “up,” “down,” “front,” “back,” “left,” “right,” “vertical,” “horizontal,” “top,” “bottom,” “inside,” “outside,” “clockwise,” “counter-clockwise,” “axial,” “circumferential,” “radial,” and the like indicate orientation or positional relationships based on the orientation or positional relationships shown in the diagrams. They are just for ease of description and simplification, not indicative or suggestive that the device or components referred to must have a specific orientation, be constructed and operate in a specific orientation, and therefore cannot be understood as a limitation of this utility application.

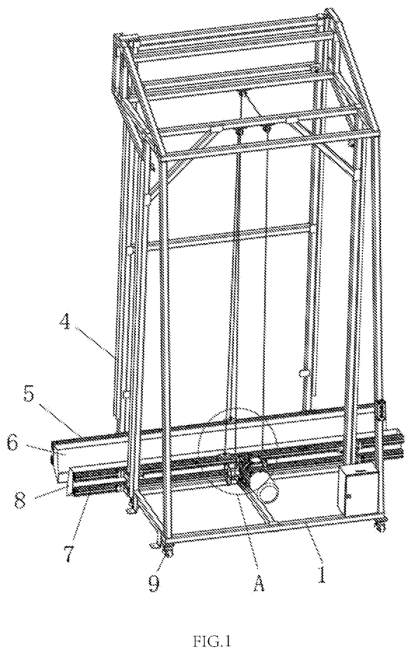

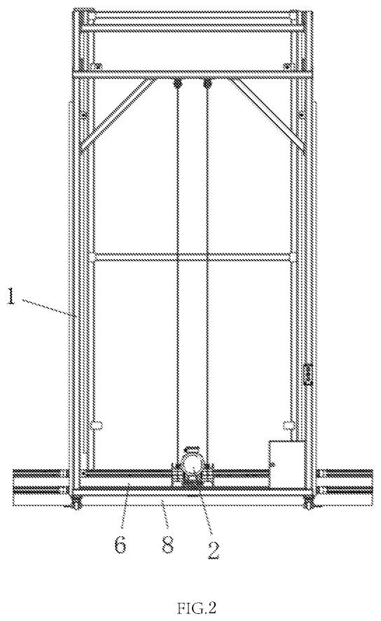

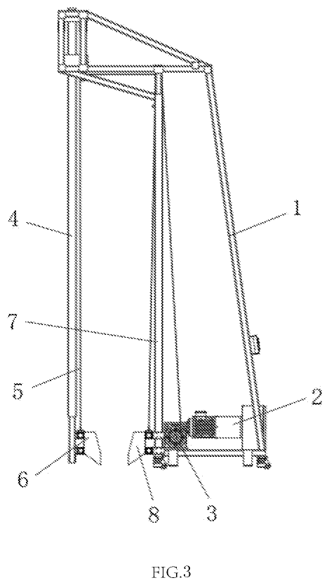

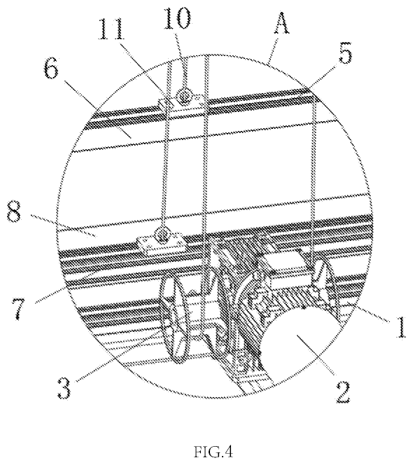

Referring to FIGS. 1-4, an automatic film-extruding 3D printer comprises a fixed support (1) and a mobile support (4). The mobile support (4) is slidably mounted on the fixed support (1). The winch machine (2) is fixedly mounted on the fixed support (1). Two winch wheels (3) are each fixedly connected to two transmission shafts on the winch machine (2). The winch ropes (10) are fixedly connected to their corresponding winch wheels (3). The first 301—profile member (5) and the second 301—profile member (7) are both fixedly mounted on the mobile support (4). The first in/out material bin (6) is fixedly mounted on one side of the first 301—profile member (5). The second in/out material bin (8) is fixedly mounted on one side of the second 301—profile member (7). Both the first 301—profile member (5) and the second 301—profile member (7) have rope fixing seats (11) mounted on them. One end of each of the two winch ropes (10) is fixedly mounted on the two rope fixing seats (11).

In this embodiment, the mobile support (4) has a roller groove, and a roller, set in the roller groove, is rotatably mounted on the fixed support (1).

In this embodiment, several universal wheels (9) are fixedly mounted at the bottom of the fixed support (1).

In this embodiment, a controller is fixedly connected to the fixed support (1) and is connected to the winch machine (2).

In this embodiment, two auxiliary wheels are rotatably connected to the fixed support (1), and the winch ropes (10) are connected to the corresponding auxiliary wheels.

In this embodiment, a rotary slot is opened on the fixed support (1), and a rotary block is fixedly connected to the auxiliary wheel. The rotary block is rotatably mounted in the rotary slot.

In this embodiment, the controller can control the winch machine (2) to start and stop. When the winch machine (2) starts, it can drive the two winch wheels (3) to rotate simultaneously. The winch wheels (3) drive the corresponding winch ropes (10) to wind, and the winch ropes (10) pull the corresponding rope fixing seats (11) to move. The rope fixing seats (11) drive the corresponding first 301—profile member (5) and the second 301—profile member (7) to move. The first 301—profile member (5) and the second 301—profile member (7) drive the corresponding first in/out material bin (6) and the second in/out material bin (8) to move. The winch ropes (10) move on the auxiliary wheels, which can stabilize the position during movement. The roller moves in the roller groove, which can stabilize the position of the mobile support (4) during movement. The universal wheels (9) can drive the fixed support (1) to move positions.

The technical advancements of this application compared to existing technology are as follows. This application teaches a 3D printer can achieve rapid film-extrusion printing on-site during actual use. It can accomplish printing faster than existing equipment for wall structures, and it also allows for moving to different positions and locations for printing structures and buildings without need to dissemble.

1. An automatic film-extruding 3D printer, comprising:
a support assembly, a winch assembly, and a moving assembly;
wherein
the support assembly comprises a fixed support (1) and a mobile support (4), and the mobile support (4) is slide-mounted on the fixed support (1);
the winch assembly comprises a winch machine (2), two winch wheels (3), and two winch ropes (10);
the winch machine (2) is firmly mounted on the fixed support (1), and the two winch wheels (3) are each firmly connected to two transmission shafts on the winch machine (2);
the winch ropes (10) are firmly connected to the corresponding winch wheels (3).

2. The automatic film-extruding 3D printer according to claim 1, wherein the moving assembly comprises a first 301 profile member, a first inlet and outlet bin (6), a second 301 profile member (7), and a second inlet and outlet bin (8);
both the first 301 profile member (5) and the second 301 profile member (7) are firmly mounted on the mobile support (4);
the first inlet and outlet bin (6) is firmly mounted on one side of the first 301 profile member (5).

3. The automatic film-extruding 3D printer according to claim 2, wherein the second inlet and outlet bin (8) is firmly mounted on one side of the second 301 profile (7);
the first 301 profile member (5) and second 301 profile (7) both have a rope fixing seat (11) firmly mounted on them; and
one end of the two winch ropes (10) are each firmly mounted on the two rope fixing seats (11).

4. The automatic film-extruding 3D printer according to claim 1, wherein the mobile support (4) is provided with a roller groove; and
the fixed support (1) is rotatably fitted with rollers that are positioned in the roller groove.

5. The automatic film-extruding 3D printer according to claim 1, wherein the bottom of the fixed support (1) is firmly fitted with multiple universal wheels (9).

6. The automatic film-extruding 3D printer according to claim 1, wherein the fixed support (1) is firmly connected to a controller; and the controller is connected to the winch machine (2).

7. The automatic film-extruding 3D printer according to claim 1, wherein the fixed support (1) is rotatably connected with two auxiliary wheels, and the winch rope (10) is connected to the corresponding auxiliary wheels.

8. The automatic film-extruding 3D printer according to claim 7, wherein the fixed support (1) is provided with a rotation groove; and the auxiliary wheel is firmly connected with a rotation block, and the rotation block is rotatably mounted in the rotation groove.

9. A method to print a structure, comprising:
providing an automatic film-extruding 3D printer of claim 1;
sending a start signal to the winch machine (2) from a controller;
driving the two winch wheels (3) to rotate simultaneously by the winch machine;
winding the ropes by rotation of the winch wheels (3) triggering the corresponding winch ropes (10) to wind, resulting in the tightening of the ropes.
driving the moving assemblies to move upwards and downwards by the rope fixing seats (11) attached to these assemblies, which are pulled along by the winch ropes (10), driving the corresponding first and second in/out material bins (6 and 8, respectively) to move as well;
extruding a film by movement of the material bins extrusion of the product, transforming it into a film.

10. The method of claim 9, wherein the winch ropes (10) move along the auxiliary wheels to ensure stable positioning during operation;
the roller, moving within the roller groove, guarantees the stable positioning of the mobile support (4);
the universal wheels (9) also aid in moving the fixed support (1) to different positions, providing further stability and flexibility to the operation.

11. The method of claim 10, further comprising stopping the winch machine (2) once the operation is complete, halting the simultaneous rotation of the winch wheels (3).
